(19) United States
(12) Patent Application Publication
(10) Pub. No.: US 2021/0071444 A1
(43) Pub. Date: Mar. 11, 2021

(54) CHILD-SAFE DOOR, CABINET, AND DRAWER LOCKING SYSTEM AND APPARATUS

(71) Applicant: Rory Wolff, Menahga, MN (US)

(72) Inventor: Rory Wolff, Menahga, MN (US)

(21) Appl. No.: 17/018,914

(22) Filed: Sep. 11, 2020

Related U.S. Application Data
(60) Provisional application No. 62/898,759, filed on Sep. 11, 2019.

(51) Int. Cl. E05B 65/00; E05B 65/46; E05B 1/00

(52) U.S. Cl. CPC E05B 65/0014; E05B 1/0007; E05B 65/46

(57) ABSTRACT

A child/pet-proofing apparatus and system is described. The apparatus is configured to facilitate the locking and unlocking of doors, cabinets, and drawers of a household while retaining the original aesthetic of the doors, cabinets, and drawers by employing the pre-existing hardware as a sophisticated manipulator of an internal locking mechanism disposed within a housing behind the face or front of the drawer or cabinet. The locking mechanism is configured to be locked and unlocked via two-step process which namely includes pushing the knob inwards and then turning the knob while it remains depressed. As the push-and-turn action is performed, an internal pocket spring is compressed, which enables the placement of locking pins into specifically arranged pin holes disposed on a drive disc. The drive disc is in communication with a lock arm which is then pivoted away from the junction of the drawer/cabinet and the surrounding cabinet housing.

This application is a non-provisional patent application of provisional patent application No. 62/898,759, filed on Sep. 11, 2019, and priority is claimed thereto.

### FIELD OF THE PRESENT INVENTION

The present invention relates to the field of child safety devices, and more specifically relates to a new form of door, cabinet, and/or drawer lock apparatus which is durable, easy to use, and blends with the overall aesthetic of the location to which it is installed.

### BACKGROUND OF THE PRESENT INVENTION

It is known that children, especially babies are curious of their surroundings. As such, they love to explore new areas of a home as soon as they are mobile. Once babies are able to ‘pull themselves up’ into a standing position, parents and guardians must take strides to ‘baby-proof’ their homes to prevent the little ones from gaining access to dangerous items and locations. For example, it is common practice to cover unused electrical outlets, place child-proofing locks on sensitive closet and bathroom doors, as well as lock cabinets and drawers which maybe low to the floor and/or within reach of the child.

Unfortunately, a majority of child-proofing and pet-proofing devices do not adhere to traditional aesthetics of a conventional home, and therefore are readily visible and stir curiosity. This can make the home appear aesthetically unappealing or disjointed, as many of the child-proofing items are composed of unsightly plastic which is often bright white and do not fit with the overall aesthetic of the home. Additionally, child-proofing mechanisms for cabinetry and drawers often requires a separate tool, such as a magnetic release, in order to facilitate the opening of the drawer or cabinet by an adult. This tool can not only be easily misplaced or lost, but it can make the process rather laborious, extending the time required to access the contents of a cabinet or drawer by several seconds. Likewise, these magnetic locks tend to require permanent installation by drilling (or screwing) holes into the wood, or by using adhesive tape, and then are uninstalled once they are no longer needed. Once the parent has another child, these locks must be manually reinstalled.

Currently there are drawbacks to hidden cabinet locks presently found on the market. Usually, they allow the cabinet or drawer to only open a short way only to suddenly or abruptly stop after the door or drawer is open approximately one inch. Because of this slight allowance, some cabinet doors crack or separate at the joint and/or damage the child lock. Namely, this is because the outward appearance of the cabinet does not inform the user of the presence of the lock until an attempt is made to open it. If there were a better form of child-proofing lock on the market, which did not provide for this inch of opening, fewer cabinets and locks would be damaged during use by those that do not expect the presence of a lock. Also, the gap allows little fingers of children to be pinched.

Other child-proofing mechanisms for drawers and cabinets are spring-tension based, and employ a plastic latch which must be depressed upon opening the cabinet or drawer an inch or so. These devices, while primarily effective, must also be removed when they are no longer needed, and then reinstalled when the parents have another baby. If there were a secure child-proofing mechanism for cabinetry and drawers which did not require uninstallation, but could be ‘deactivated’ until needed again for a second (or third, etc.) child, but that also exhibited an aesthetically pleasing design which matched the style of the home, more parents/guardians would employ the child-proofing mechanisms without detracting from the beauty and utility of their home.

Similarly, child-proofing mechanisms for entryway doors are known to use a plastic cover configured to encompass the doorknob to prevent easy turning of the doorknob by a child. These systems tend to be only temporarily effective, as eventually the child will learn to remove the plastic enclosure by applying pressure, or may learn to circumvent the mechanism entirely as holes are traditionally present in the enclosure to permit adults to access the doorknob within. Such mechanisms are generally obtrusive and do not match the aesthetic of the home. If there were a better childproofing mechanism which could be integrated into the doorknob itself, the mechanism would be much more effective while also having the capacity of matching the overall aesthetic of the home.

In short, the market is presently lacking in a good child-proofing system for doors, cabinets, and drawers which appears ‘invisible,’ is easy to use for adults, and is capable of matching the style and aesthetic of the home. Thus, there is a need for a new form of child-proofing system and apparatus configured to facilitate the access to doors, cabinets, and drawers easily from adults while preventing child access. Such a system is preferably aesthetically pleasing, and may be deactivated (left installed, but idle) when it is no longer needed. Another thing is that most other child locks require the use of both hands, whereas the present invention requires only one hand for use, which is nice when holding babies or other small children.

### SUMMARY OF THE PRESENT INVENTION

The present invention is a child-proofing and/or pet-proofing system and apparatus for doors, cabinets, and/or drawers which is configured for use within the household once a child or pet is mobile. The present invention exhibits the characteristics of conventional doorknob, cabinet, and/or drawer hardware, commonly seen as a metallic knob, pull handle, or similar hardware which facilitates manipulation of the door, cabinet, or drawer via a hand. Unlike child-proofing solutions found in the prior art, the present invention may be deactivated, either permanently or temporarily. As such, once there is no longer a need for child/pet-proofing devices, the parent/guardian need not uninstall the apparatus of the present invention, but instead can leave it ‘inactive’ until a subsequent child is born and is in need of child-proofing devices, or a new pet is brought into the home and is need of the system. Likewise, unlike other child/pet-proofing devices presently on the market, the locking mechanism is hidden behind the drawer or door, and therefore exhibits the appearance of a conventional knob (cabinet/drawer hardware) and is available in a variety of shapes, styles, colors, and textures in order to match the overall aesthetic of the kitchen or home at large.

The present invention employs an internal, pin-based locking mechanism with a threaded rod to which the doorknob or cabinet knob/hardware is attached. The locking mechanism requires two simple steps to operate unlike similar child-proofing locks present on the market. An adult user must first grasp the knob and push inwards. This is counter-intuitive for the child, who wishes to pull open the drawer or cabinet. Second, the adult user turns the knob while the knob is depressed, unlocking the mechanism and facilitating access through the door, or to the interior of the drawer or cabinet. Releasing the hold on the knob allows a spring to disengage the mechanism, allowing the knob to be rotated freely with no effect on the mechanism. This required action (push and turn) is counter intuitive to the child or pet, who intuitively pulls the drawer or door towards them. Rotation of the knob without results also impedes the child's further action.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

The present invention will be better understood with reference to the appended drawing sheets, wherein:

FIG. 1 shows an exploded perspective view of the individual components of the first preferred embodiment of the present invention disassembled as seen from the top and side.

FIG. 2 exhibits a view of the external components of the first preferred embodiment of the present invention as fully assembled and installed on a cabinet door.

FIG. 3 shows an exploded perspective view of a second preferred embodiment of the apparatus of the present invention configured for use on passage doors, including the knob and locking mechanism, isolated from a location of installation as seen from the side.

FIG. 4 details a view of the second preferred embodiment of the present invention, shown assembled.

FIG. 5 depicts a flow chart detailing the process of installation of the system and apparatus of the present invention.

FIG. 6 exhibits a flow chart detailing the process of locking and unlocking the apparatus of the present invention once properly installed.

### DETAILED DESCRIPTION OF THE PREFERRED EMBODIMENT

The present specification discloses one or more embodiments that incorporate the features of the invention. The disclosed embodiment(s) merely exemplify the invention. The scope of the invention is not limited to the disclosed embodiment(s). The invention is defined by the claims appended hereto.

References in the specification to “one embodiment,” “an embodiment,” “an example embodiment,” etc., indicate that the embodiment described may include a particular feature, structure, or characteristic, but every embodiment may not necessarily include the particular feature, structure or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

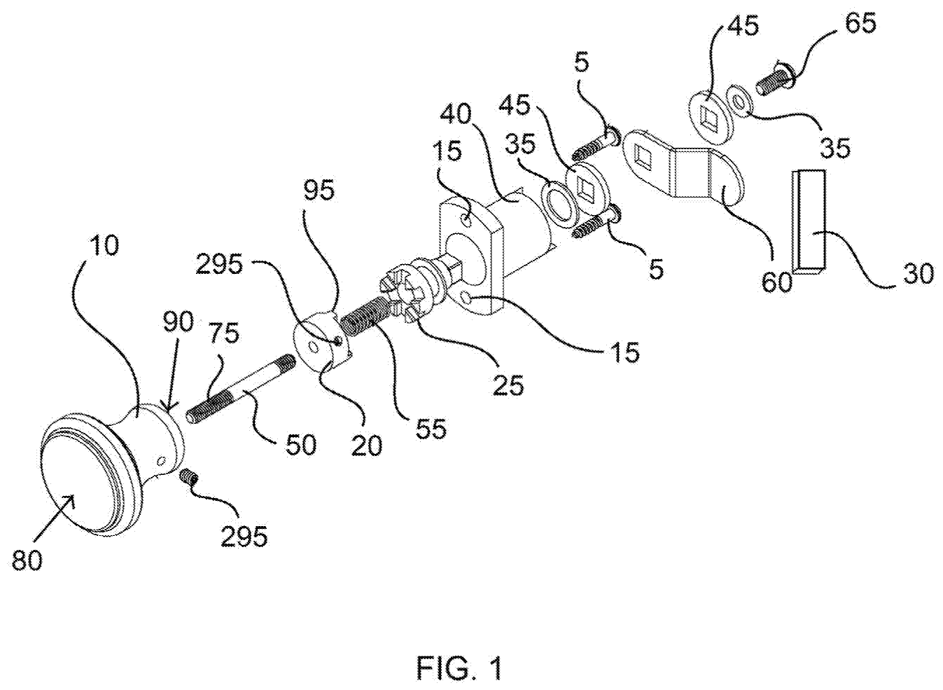

The present invention is a child-proofing and pet-proofing apparatus and system configured for use by parents, guardians, preschool teachers, camp counselors, and others conventionally tasked with caring for babies, young children, and/or pets. There are two preferred embodiments of the present invention: a cabinet and drawer locking embodiment and an entryway door embodiment. The cabinet and drawer embodiment of the present invention is equipped with a knob (10), a drive disc (20), a strike slide plate (30), a housing (40), a drive bolt (50), and a lock arm (60). The drive bolt (50) of the present invention is preferably equipped with a threaded shaft (75) and mating holes (70) which are preferably arranged in a three bolt pattern or a six bolt pattern as seen in FIG. 1. The knob (10) has a front (80) and a rear (90). The rear (90), is preferably equipped with a threaded hole configured to mate with the threaded shaft (75) of the drive bolt (50). At least one set screw (295) is preferably used to secure the knob (10) to the threaded shaft (75) of the drive bolt (50). The drive bolt (50) is configured to be placed through a drilled hole which is conventionally present on drawers and cabinets for the attachment of hardware. Once through the hole, pins (95) or pegs are present, and are preferably spring-loaded (via a pocket spring (55)) such that they remain retracted when the apparatus is in the locked position. At least one nylon washer (35) bridges the gap between the drive bolt (50) and the rear (90) of the knob (10).

Since cabinet door style influences the overall design of the apparatus and system of the present invention, three major design considerations are addressed: conventional rabbet door styles, partial overlay doors (which favor the pin or peg), and the disc mechanism design which consists of the clutch knob disc (20) where the threaded end of a cabinet knob is attached. The opposite end features the clutch knob disc (20) which contains at least one pin (95) configured to engage a clutch latch disc (25) containing six mating holes (70). The two surfaces are preferably separated by a pocket spring (55) which prevents unintended engagement as shown in FIG. 1. The opposite end of the drive disc (20) features a square end shaft (85) which engages a square hole within a spacer (45) and a square hole in the lock arm (60), and enables adjustment for door thickness through the use of square hole washers.

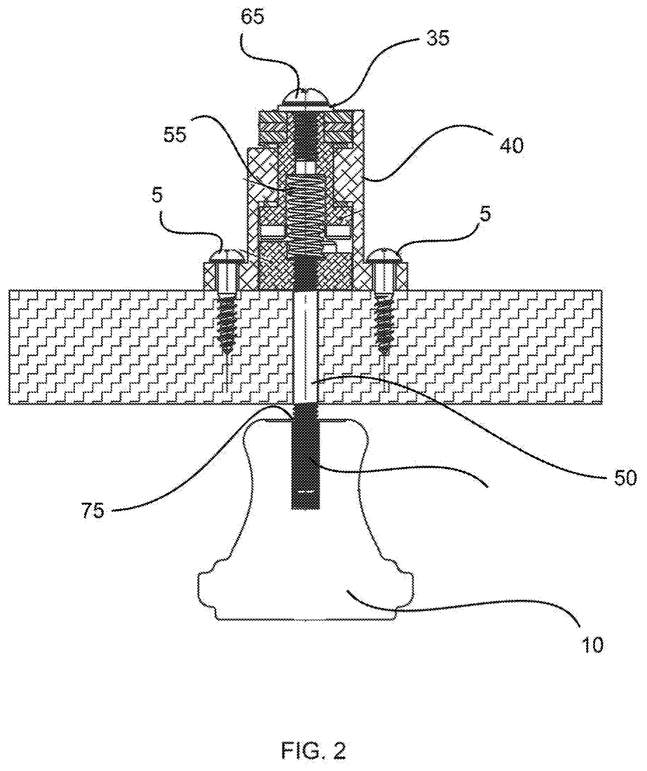

The mechanism of the present invention is contained within the housing (40) to be located on the inside face of the cabinet door or drawer as shown in FIG. 2. The protruding threaded shaft (75) is passed through the face of the cabinet door or drawer where the knob (10) or door hardware is installed on the front of the cabinet or drawer. The knob (10) is spaced through a forked spacer plate to allow the required space (gap) between the cabinet face and the back side of the knob. This space is required to allow the knob (10) to be pushed inwards to engage the locking mechanism of the present invention.

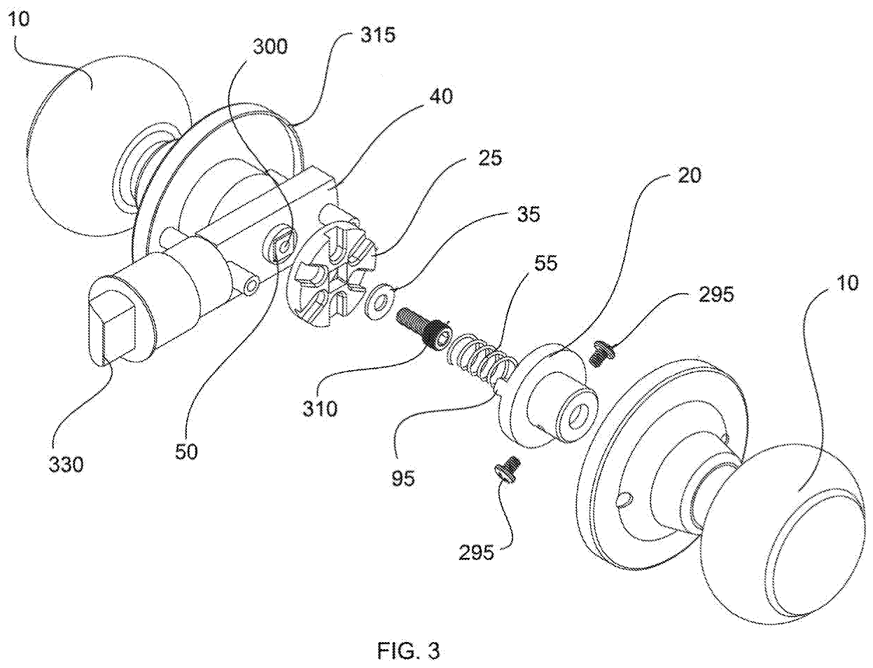

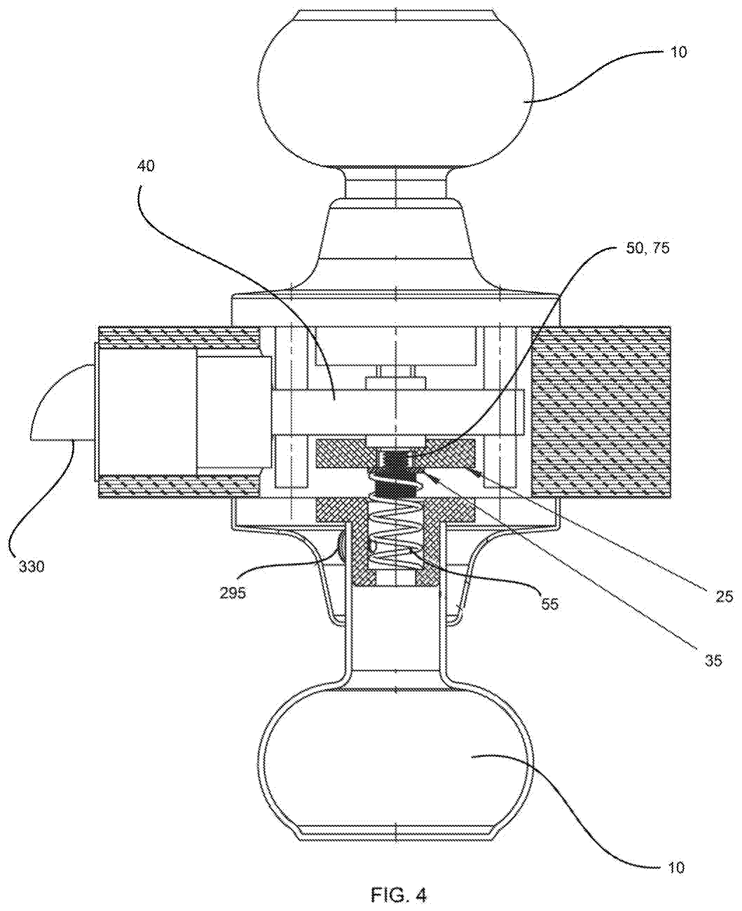

In passage way door embodiments of the apparatus of the present invention as shown in FIG. 3 and FIG. 4, the housing (40) of the present invention preferably contains the strike slide plate (30), and is configured to accept the drive disc (20). The drive disc (20) is disposed in communication with the drive bolt (50) via the square hole (45) and ultimately, the knob (10) via the threaded shaft of the drive bolt (50). In short, the locking mechanism of the present invention includes the drive bolt (50), threaded on one end (the threaded shaft (75)) to receive the knob (10), and with a square head (85) which engages the drive disc (20) at the square hole (45). The drive disc (20) is equipped with at least one pin (95), which engages at least one mating hole (70) in the lock arm (60). The lock arm (60) is preferably available in two iterations of differing size, allowing for adjustment to accommodate different cabinet face thicknesses. The lock arm is secured to the housing via a bolt (65).

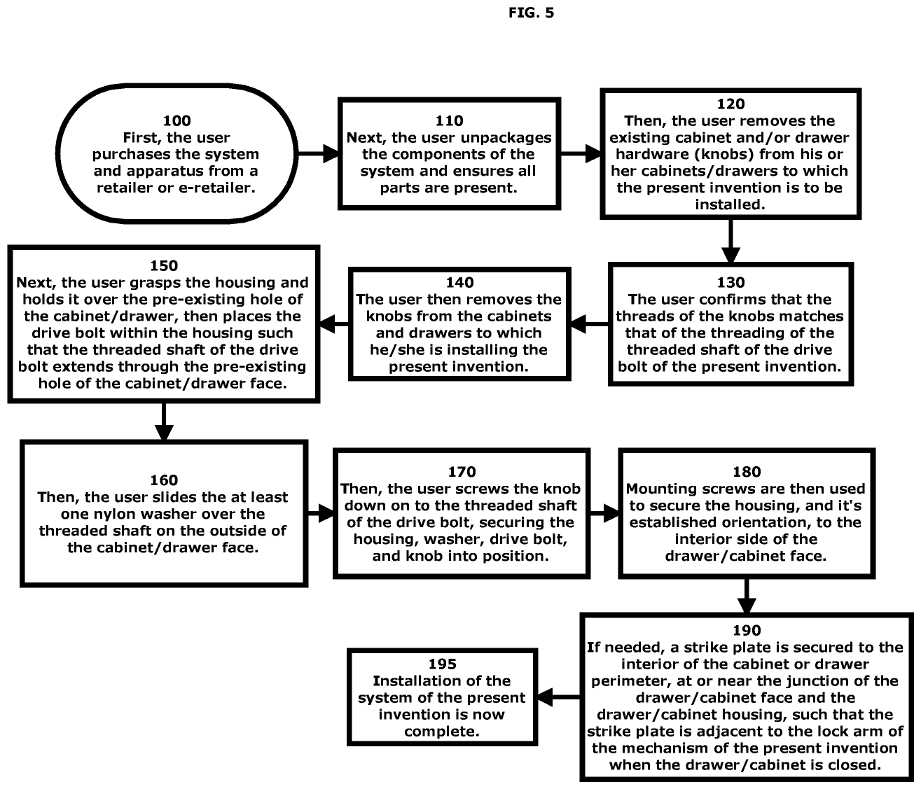

The process of installation of the system and apparatus of the present invention, as shown in FIG. 5, is preferably as follows:
1. First, the user purchases the system and apparatus from a retailer or e-retailer. (100)
2. Next, the user unpackages the components of the system and ensures all parts are present. (110)
3. Then, the user removes the existing cabinet and/or drawer hardware (knobs) from his or her cabinets/drawers to which the present invention is to be installed. (120)
4. The user confirms that the threads of the knobs matches that of the threading of the threaded shaft of the drive bolt of the present invention. (130) If the threads match, the user proceeds. If the threads do not match, the user is required to purchase an alternate drive bolt for use with the system of the present invention, or new knobs which exhibit standardized threading compliant with the included threaded shaft of the present invention.
5. The user then removes the knobs from the cabinets and drawers to which he/she is installing the present invention. (140)
6. Next, the user grasps the housing and holds it over the pre-existing hole of the cabinet/drawer, then places the drive bolt within the housing such that the threaded shaft of the drive bolt extends through the pre-existing hole of the cabinet/drawer face. (150)
7. Then, the user slides the at least one nylon washer over the threaded shaft on the outside of the cabinet/drawer face. (160)
8. Then, the user screws the knob down on to the threaded shaft of the drive bolt, securing the housing, washer, drive bolt, and knob into position. (170) The orientation of the housing is adjusted according to the opening orientation of the cabinet or drawer (horizontal for most drawers, vertical for most cabinets).
9. Mounting screws are then used to secure the housing, and it's established orientation, to the interior side of the drawer/cabinet face. (180) Two screw holes (15) are present on the housing through which the mounting screws (5) are disposed.
10. If needed, a strike plate is secured to the interior of the cabinet or drawer perimeter, at or near the junction of the drawer/cabinet face and the drawer/cabinet housing, such that the strike plate is adjacent to the lock arm of the mechanism of the present invention when the drawer/cabinet is closed. (190)
11. Installation of the system of the present invention is now complete. (195)

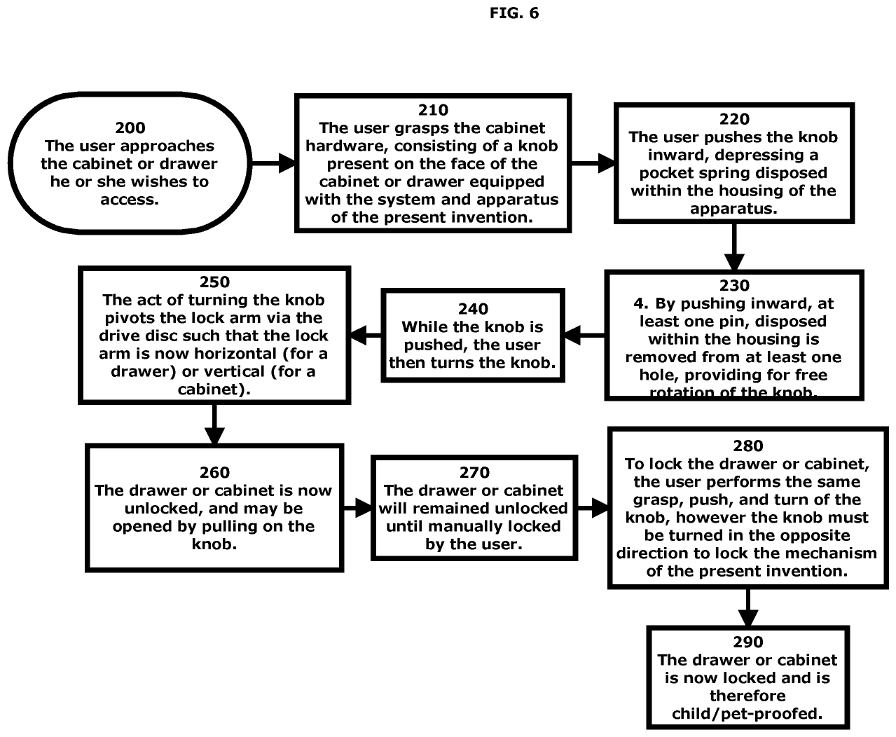

The process of use of the system and apparatus of the present invention, as shown in FIG. 6, is preferably as follows:
1. The user approaches the cabinet or drawer he or she wishes to access. (200)
2. The user grasps the cabinet hardware, consisting of a knob present on the face of the cabinet or drawer equipped with the system and apparatus of the present invention. (210)
3. The user pushes the knob inward, depressing a pocket spring disposed within the housing of the apparatus. (220)
4. By pushing inward, at least one pin, disposed within the housing is removed from at least one hole, providing for free rotation of the knob. (230)
5. While the knob is pushed, the user then turns the knob. (240)
6. The act of turning the knob pivots the lock arm via the drive disc such that the lock arm is now horizontal (for a drawer) or vertical (for a cabinet). (250)
7. The drawer or cabinet is now unlocked, and may be opened by pulling on the knob. (260)
8. The drawer or cabinet will remained unlocked until manually locked by the user. (270)
9. To lock the drawer or cabinet, the user performs the same grasp, push, and turn of the knob, however the knob must be turned in the opposite direction to lock the mechanism of the present invention. (280)
10. The drawer or cabinet is now locked and is therefore child/pet-proofed. (290)

It should be understood that a cabinet drawer or door must have a standard-sized hole present for the proper installation of the threaded shaft (75) to which the knob (10) may be fastened. In cases in which a hole is not previously present, an optional drill fixture is preferably available. A preexisting hole often can be used for inserting the threaded shaft (75) through the cabinet door or drawer. It should be understood that the present invention is configured to use the preexisting cabinet hardware as the knob (10) of the present invention. As such, the threads of the threaded shaft (75) are preferably standardized, however it is envisioned that alternate embodiments of the threaded shaft (75) may be available separately or bundled with the purchase of the present invention in order to accommodate cabinet hardware exhibiting non-standard threading.

The second primary embodiment of the present invention, referenced as a “Passage Door Knob Mechanism” as shown in FIG. 3 and FIG. 4, exhibits a design which utilizes a modified form of knob (10) of a current production. Such a design preferably involves the use of two knobs (10), one for each side of the passage door as shown in FIG. 3. As such, this embodiment of the present invention is for use on passage doors equipped with conventional door knobs such as bathroom doors, outside doors, bedroom doors, etc. The knob side which contains the drive square tube features a tube length that is sized to allow the tube to extend past the spring latch assembly and engage the clutch head. The square tube is internally fitted with a threaded plug (300) which secures the clutch latch disc (25) to the tube with an 8 mm flat head socket head bolt (310). The opposite side knob, guided by the trim flange assembly (315), is fitted to the male drive head attached to the shank portion of the knob containing the drive pins and pocket spring (55), preventing unintended engagement of the mechanism. This assembly allows the knob to be pushed inwards and turned, engaging the clutch latch disc (25) (effectively the female clutch head) controlling the spring bolt-latch assembly (330). When released, the knob (disengaged) can freely spin.

Additionally, other alternate embodiments of the present invention may be configured with differing or extra security precautions which may amount to different forms of knobs (10) to be used with the present invention. For example, alternate embodiments of the present invention may come pre-equipped with one or more knobs (10) which may include a central core configured to be pushed inwards as opposed to the entirety of the knob (10), making it slightly more difficult for children to navigate the locking mechanism. In contrast to the standard hardware of the knob (10) of the preferred embodiment of the present invention, alternate embodiments of the knob (10) may only be configured to be depressed in part, rather than in its entirety. Similarly, some embodiments of the present invention may be configured to be first pulled, then turned, and then pushed inwards prior to unlocking of the mechanism of the present invention. Other alternate embodiments of the present invention may require the knob to be turned in a certain direction, or to a specific angle in order to unlock the mechanism of the present invention to facilitate access to the inside of the door by an adult.

Some embodiments are preferably equipped with a 90-degree stopping mechanism which ensures that the knob (10), once properly pushed inwards for use, may not rotate beyond 90-degrees, at which point the mechanism is unlocked or locked (depending on the direction of the turn). When not pushed inwards, it is envisioned that the knob (10) may freely rotate 360 degrees.

It should be understood that all designs of the system and apparatus of the present invention are subject to slight modifications, as dictated by cabinet constructions prevalent at the time of installation. Modifications may include, but are not limited to, variations on the number and placement of drive pins, their size, shape, and location.

Having illustrated the present invention, it should be understood that various adjustments and versions might be implemented without venturing away from the essence of the present invention. Further, it should be understood that the present invention is not solely limited to the invention as described in the embodiments above, but further comprises any and all embodiments within the scope of this application.

The foregoing descriptions of specific embodiments of the present invention have been presented for purposes of illustration and description. They are not intended to be exhaustive or to limit the present invention to the precise forms disclosed, and obviously many modifications and variations are possible in light of the above teaching. The exemplary embodiment was chosen and described in order to best explain the principles of the present invention and its practical application, to thereby enable others skilled in the art to best utilize the present invention and various embodiments with various modifications as are suited to the particular use contemplated.

I claim:

1. A child-proofing knob and lock mechanism for passageway doors, cabinets, and drawers which must first be pressed in then turned to facilitate access comprising:
a knob, said knob equipped with a front and a rear;
a drive bolt, said drive bolt equipped with at least one threaded shaft;
wherein said rear of said knob is disposed in communication with said drive bolt via said at least one threaded shaft;
a set screw, said set screw configured to maintain a static position of said knob on said at least one threaded shaft of said drive bolt;
a housing, said housing disposed inline with said drive bolt;
a clutch knob disc, said clutch knob disc equipped with at least one pin;
a clutch latch disc, said clutch latch disc equipped with mating holes;
wherein said mating holes are in line with said at least one pin;
a pocket spring, said pocket spring disposed around said drive bolt;
a lock arm, said lock arm disposed in communication with said drive bolt;
wherein said lock arm is disposed outside of said housing;
wherein said pocket spring is disposed in communication with said clutch latch disc and said housing;
wherein said clutch latch disc, said pocket spring, and said clutch knob disc are disposed within said housing;
wherein said clutch latch disc is configured to come into contact with said clutch knob disc when said knob is pressed inwards, compressing said pocket spring to facilitate connection of said at least one pin to said at least one mating hole; and
wherein upon connection of said at least one pin to said at least one mating hole, turning of the knob engages movement of said lock arm.
